(19) United States
(12) Patent Application Publication
(10) Pub. No.: US 2003/0155348 A1
(43) Pub. Date: Aug. 21, 2003

(54) Antenna radiation heater for heating a material by using resonance

(76) Inventor: Helmut Reichelt, Dresden (DE)

Correspondence Address: Cort Flint, McNair Law Firm, P O Box 10827, Greenville, SC, 29603-0827, US

(21) Appl. No.: 10/333,558

(22) PCT Filed: Jun. 1, 2001
(86) PCT No.: PCT/EP01/06239

(30) Foreign Application Priority Data
Jul. 29, 2000 (DE) 100 37 027.6

(51) Int. Cl. H05B 6/10

(52) U.S. Cl. 219/645; 219/671; 219/675

(57) ABSTRACT

The invention relates to an antenna radiation heating (2) to heat a matter by means of resonance with several surface antenna elements (3), each consisting of a carrier surface material (11) and a radiation coating (10) applied thereon which is delimited by two spaced electrical conductors (14, 15) in parallel, with electrical contact as antenna limiter and with which high-frequency electromagnetic radiation can be emitted. Furthermore, this antenna radiation heating (2) comprises a harmonic generator which is coupled to the two electrical conductors (14, 15) of a surface antenna element (3) for an excitation of the radiation coating (10) for emitting an oscillation spectrum within the range of molecular natural frequencies of the matter to be heated. In accordance with the invention, the radiation coating (10) is unilaterally applied to the carrier surface material (11) and forms an element front facing a matter to be heated. Furthermore, a contact protection layer (12) is applied to the radiation coating (10) which, on the one hand, electrically insulates the radiation coating (10) against contact and, on the other hand, enables the emission of the oscillation spectrum without or at least with only minor attenuation.

The invention relates to an antenna radiation heating to heat a matter by means of resonance, according to the introductory clause of claim 1.

A known generic antenna radiation heating to heat a matter by means of resonance (WO00/25552) comprises several surface antenna elements which each consist of a carrier surface material and a radiation coating applied thereto which is delimited by means of two spaced, parallel electrical conductors with electrical contact as antenna limiter. With this radiation coating, high-frequency electromagnetic radiation can be emitted. Moreover, the antenna radiation heating comprises a harmonic generator which is coupled to the two electrical conductors of a surface antenna element for excitation of the radiation coating to emit an oscillatory spectrum within the range of molecular natural frequencies of the matter to be heated.

Moreover, a suitable radiation coating is specified there which generates a suitable radiation spectrum with the described excitation.

Furthermore, a multiple arrangement of surface antenna elements is shown such that in a corner of a room twelve rectangular surface antenna elements—four each side by side and three on top of each other—are arranged with small spacings and electrically connected in parallel. The drive is here effected by means of the harmonic generator.

It has been shown that—for an efficient room heating function—the surface antenna elements should have a relatively large area, the individual surfaces not being randomly enlargeable since the heating effect would then be reduced again. Accordingly, it is expedient to use the specified or a similar multiple arrangement of surface antenna elements.

Control of the electrical supply wires is in the low voltage range, e.g. at 24 volt. Thus, the operationally relatively cool radiation coating of a surface antenna element can be touched without the risk of electric shock, i.e. touching is entirely noncritical. Surprisingly, however, it has been found that considerable potential differences may occur between the surface antenna elements of a multiple arrangement. In parallel connections, this might be due to the phase shifts of the oscillatory spectrums of the individual surface antenna elements. In the event that several surface antenna elements are within reach of a technician or a heating user, there is thus the risk of electric shock if two or more surface antenna elements are simultaneously touched. Although such electric shock is, as a rule, not dangerous or hazardous to health, it may be experienced as being extremely unpleasant.

Until now, this problem has not been recognized within the state of the art and has not been described either.

Accordingly, it is the object of the invention to develop a generic antenna radiation heating such that the risk of electric shocks will no longer be given.

This object is realized through the characteristics of claim 1.

According to claim 1, the radiation coating is applied on one side on the carrier surface material and forms an element front, facing the matter to be heated. Furthermore, a contact protection layer is applied to the radiation coating. The material of such a contact protection layer shall be selected such that, on the one hand, the radiation coating is electrically insulated against contact and, on the other hand, the emission of the oscillatory spectrum is possible without any or at least only minor attenuation. The two properties of the radiation coating are essential in this combination—as an electrical insulation layer to avoid electric shocks upon touching two elements, and for an attenuation-free radiation or, respectively, a low-attenuation radiation of the emission of the oscillatory spectrum.

According to claim 2, the carrier surface material as the element's reverse side should preferably also have electrical insulation properties; however, as opposed to the contact protection layer, it should either entirely or at least very much attenuate the emission of the oscillatory spectrum. Thus will be achieved that the radiation energy as a whole or at least a major part of it will be emitted via the element front which will result in a particularly energy-saving heating of the matter.

A suitable contact layer according to claim 3, having the above specified properties, may consist of an aqueous, finely dispersed, softener-free, medium viscosity copolymer dispersion of acrylic and methacrylic acid esters which advantageously has a solids concentration of approx. 50% and an average particle size of approx. 0.1 μm.

Alternatively, a suitable contact layer according to claim 4 may consist of an aqueous, protective colloidal, medium viscosity polymer dispersion of vinyl acetate, versatic acid vinyl ester and maleic acid di-n-butyl ester, advantageously having a solids concentration of approx. 50-55% and an average particle size of approx. 0.2 μm.

The coating material of the radiation coating can be selected in a manner proven and known per se in accordance with the composition specified in claim 5. The specified sulfonated oil here preferably consists of sulfonated ricinus oil and the specified phenols are advantageously carbonized phenols produced by cracking, or benzisothiazolinone is used. As a thinning agent, a solvent based on aromatics and/or alcohol and/or ester and/or ketone has proven well, whereas an inorganic and/or organic, monomeric and/or polymeric substance is particularly suitable as a dispersing agent. Insulating soot is suitable as an insulator, and the coating material should contain a thixotropy agent.

The radiation coating and the contact protection layer can be applied and produced by methods known per se. According to claim 6, the radiation coating and/or after its firming up the contact protection layer are produced, especially advantageously, by means of blade spreading. In particular, the substance amounts of casein or, possibly, of polyacrylates in combination with a blade spreading method cause a radiation attenuation toward the element's reverse side, especially if the radiation coating is applied to paper material. The contact protection layer is also expediently produced by blade spreading, with layer gauges of approx. 5-10 μm regularly being sufficient for contact protection and, at that, still not causing any unfavorable attenuation of emission on the element's front side.

In a manner known per se, a suitable excitation of the radiation coating according to claim 7 is possible such that the harmonic generator as a component of a control/regulating device comprises an electrical block which—upon control with a control oscillation—shows a steep current speed increase in accordance with a steep rising curve and thus being suitable for producing a high harmonic percentage. The electrical block may be, for example, a Triac or a double MOS FET with the allocated electronic control components known per se. The resonance arrangement takes the required energy as needed from the connected electrical network, with the heating effect being at least partly controllable and/or adjustable by changing the amplitudes and/or the frequency of the control oscillations.

According to claim 8, it is expedient to design the electrical conductors in a manner known per se as copper foil strips arranged in parallel. A covering of copper foil strips known per se as antenna limiters with an electrical insulating layer (DD 208 029) can also be realized. The electrical contact to the radiation coating is designed as a capacitive and/or inductive coupling.

The indicated contact protection is especially essential if—according to claim 9—the multiple antenna surface elements are arranged within mutual reach, electrically connected in parallel and excitable by means of a harmonic generator. Even if several harmonic generators are used for the antenna surface elements, there is the risk of an electric shock due to the above mentioned potential differences so that a contact protection with an electrical insulation layer is essential here as well.

A compact, visually pleasing arrangement results in a manner known per se according to claim 10 if all antenna surface elements have an identical right-angled surface and are connected in parallel in a symmetrical arrangement with short lengths of supply lines.

The invention is described in more detail by way of a drawing.

It shows:

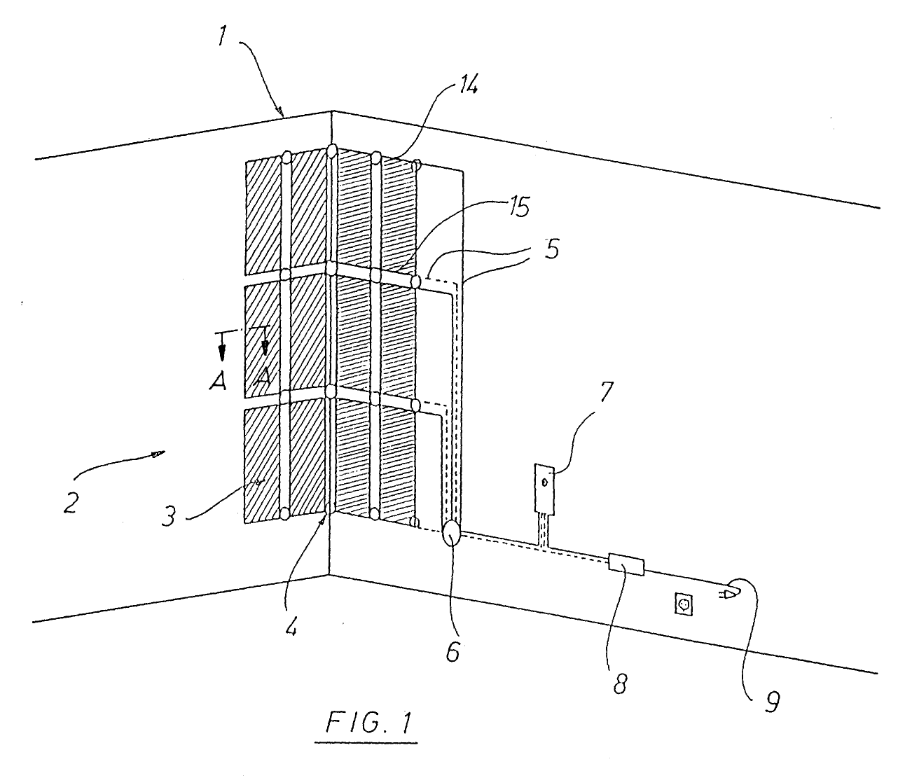

FIG. 1 a perspective representation of an antenna radiation heating to heat a matter, as a space heating, and

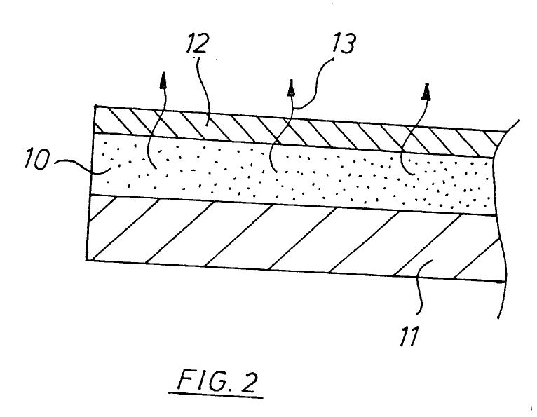

FIG. 2 a schematic cross-sectional view along line A-A of FIG. 1.

FIG. 1 is a perspective representation of a corner of a room 1 in which an antenna radiation heating 2 is installed. The antenna radiation heating 2 here consists, by way of example, of a combination of twelve surface antenna elements 3 which are symmetrically grouped in horizontal groups of four surface antenna elements 3 in room corner 1.

Here, the surface antenna elements 3 are designed as right-angled surface elements and are each connected on their narrow sides with each other in connecting points 4 as parallel connections. Three vertical, edge-side surface antenna elements 3 each are connected by connection cable 5 via a distributor box 6 and with the other surface antenna elements 3 and, respectively, their electrical conductors 14, 15 as copper foil strips via the parallel connections 4.

A control device 7 contains in particular a harmonic generator which in turn comprises an electrical block which upon control with a control oscillation shows a steep current increase speed in accordance with a steep rising edge and thus is suitable for generating a high harmonic percentage. Such an electrical block may be, for example, a Triac or a double MOS FET which has the electronic control components known per se. The control device 7 is, on the one hand, connected via distributor box 6 with the surface antenna elements 3 and, on the other hand, is supplied via a transformer 8 via a power supply connection 9.

As is especially evident from FIG. 2 which shows a schematic partial sectional view along line A-A of FIG. 1, the surface antenna elements 3 each consist of a carrier surface material 11 and a radiation coating 10 applied thereon, with the radiation coating 10 being applied unilaterally on the carrier surface material 11 and thus forming an element front which faces a matter to be heated, e.g. a person in the room. As can furthermore be taken from FIG. 2, a contact protection layer 12 is applied to the radiation coating 10, the former being in comparison with the latter preferably relatively thin; the radiation coating 10, on the one hand, being electrically insulated against contact and, on the other hand, enabling the emission of the oscillation spectrum without or at least with only minor attenuation.

In contrast, the carrier surface material 11 as the element's reverse side electrically insulates, on the one hand, the radiation coating 10 against contact and, on the other hand, prevents the emission of the oscillation spectrum entirely or at least with considerable attenuation.

Exemplarily, the contact protection layer 12 here consists of an aqueous, finely dispersed, softener-free, medium viscosity copolymer dispersion of acrylic and metacrylic acid esters.

Moreover, FIG. 2 presents with arrows 13 the emission of the oscillation spectrum.

The radiation coating 10 and, after its firming up, the contact protection layer 12 as well, can each be blade spread onto the carrier surface material 11.

The electrical contact from the electrical conductors 14, 15—designed as copper foil strips arranged in parallel—to the radiation coating 10 is achieved via a capacitive and/or inductive coupling, with the radiation coating 10 lying under or over the electrical conductors 14, 15, or, respectively, alternatively thereto, these being embedded in the radiation coating 10 which, however, is not presented here.

Thus, such an arrangement of the antenna radiation heating 2 from a plurality of surface antenna elements 3 which are arranged within mutual reach will entirely preclude the risk of an electric shock upon contact with two or more surface antenna elements 3 by a technician.

1. Antenna radiation heating to heat a matter by means of resonance,
with several surface antenna elements, each consisting of a carrier surface material and a radiation coating applied thereon which is delimited by two spaced parallel electrical conductors with electrical contact as antenna limiters and with which high-frequency electromagnetic radiation can be emitted, and
with a harmonic generator which is coupled to the two electrical conductors of a surface antenna element for an excitation of the radiation coating for the emission of an oscillation spectrum within the range of molecular natural frequencies of the matter to be heated,
characterized in that
the radiation coating (10) is applied unilaterally onto the carrier surface material (11) and forms an element front, facing a matter to be heated and a contact protection layer (12) being applied on the radiation coating (10) which, on the one hand, electrically insulates the radiation coating (10) against contact and, on the other hand, enables the emission of the oscillation spectrum without or at least with only minor attenuation.

2. Antenna radiation heating according to claim 1, characterized in that the carrier surface material (11) as the element's reverse side, on the one hand, electrically insulates the radiation coating (10) against contact and, on the other hand, prevents the emission of the oscillation spectrum entirely or at least with considerable attenuation.

3. Antenna radiation heating according to claim 1 or claim 2, characterized in that the contact protection layer (12) consists of an aqueous, finely dispersed, softener-free, medium viscosity copolymer dispersion of acrylic and methacrylic acid esters.

4. Antenna radiation heating according to claim 1 or claim 2, characterized in that the contact protection layer (12) consists of an aqueous, protective colloidal, medium viscosity polymer dispersion of vinyl acetate, versatic acid vinyl ester and maleic acid- di-n-butyl ester.

5. Antenna radiation heating according to any one of the claims 1 to 4, characterized in that the coating material of the radiation coating (10) is composed of binding agent, insulator, dispersing agent, water and graphite and has the following composition
a. 55 to 65% amount of substance of a base material comprising
39 to 49% amount of substance binding agent,
18 to 23% amount of substance insulator,
18 to 24% amount of substance dispersing agent,
12 to 16% amount of substance distilled water and
b. 35 to 45% amount of substance graphite,
the composition of the binding agent being

| | |
|---|---|
| 64 to 79% | amount of substance distilled water, |
| 4 to 6% | amount of substance sulfonated oil, |
| 0.15 to 0.24% | amount of substance phenols, or 0.05 to 0.5% amount |
| | of substance benzisothiazolinone, |
| 15 to 19% | amount of substance casein, |
| 0.8 to 1.2% | amount of substance urea, |
| 2 to 3 % | amount of substance alkaline thinning agent, and |
| 2.5 to 3.5 % | amount of substance caprolactam. |

6. Antenna radiation heating according to any one of the claims 1 to 5, characterized in that the radiation coating (10) and/or, after its firming up, the contact protection layer (12) are produced by means of blade spreading.

7. Antenna radiation heating according to any one of the claims 1 to 6, characterized in that the harmonic generator as a component of a control/regulating device (7) comprises an electrical block which, upon control with a control oscillation, shows a steep current increase speed in accordance with a steep rising edge and thus is suitable for generating a high harmonic percentage.

8. Antenna radiation heating according to any one of the claims 1 to 7, characterized in that the electrical conductors are designed as copper foil strips (14, 15) arranged in parallel and the electrical contact for radiation coating (10) being designed as a capacitive and/or inductive coupling, with the radiation coating (10) lying under or over the copper foil strips (14, 15) or that these are embedded in the radiation coating.

9. Antenna radiation heating according to any one of the claims 1 to 8, characterized in that the several surface antenna elements (3) are arranged within mutual reach, electrically connected in parallel and excitable by means of a harmonic generator.

10. Antenna radiation heating according to any one of the claims 1 to 9, characterized in that all surface antenna elements (3) have an identical right-angled surface and are connected in parallel in a symmetrical arrangement with short lengths of supply lines.
